(19) United States
(12) Patent Application Publication
(10) Pub. No.: US 2025/0268151 A1
(43) Pub. Date: Aug. 28, 2025

(54) VERTICAL PLANT GROWTH SYSTEM

(71) Applicant: Loom Gardens, Inc., Springfield, IL (US)

(72) Inventors: Wesley Tyler Casper, Springfield, IL (US); Manolya Rowe, Auburn, IL (US)

(21) Appl. No.: 19/061,884

(22) Filed: Feb. 24, 2025

Related U.S. Application Data
(60) Provisional application No. 63/556,972, filed on Feb. 23, 2024.

(51) Int. Cl. A01G 7/04; A01G 9/02; A01G 9/24

(52) U.S. Cl. CPC A01G 7/045; A01G 9/02; A01G 9/247

(57) ABSTRACT

A plant growth system for growing one or more plants is provided. The system may be wall mountable and includes a decorative cover. The system may provide automated environmental controls and may include a sensor module for monitoring plant conditions and environmental parameters, a processor or controller for analyzing sensor data and determining optimal growth conditions, and an actuation module for automatically adjusting grow light intensity and nutrient delivery via a hydroponic module. The system may further include a user interface module with an electronic display and a mobile application for user interaction and remote control. The plant growth system may have a modular design, allowing for interchangeable components and customization of the aesthetic and/or functional properties of the system. The cover may function as an in-situ germination chamber.

### CROSS-REFERENCE TO RELATED APPLICATIONS

This application claims priority under 35 U.S.C. § 119 to U.S. Provisional Patent Application No. 63/556,972, filed Feb. 23, 2024, the entirety of which is hereby incorporated by reference.

### FIELD OF THE INVENTION

The present invention relates generally to a plant-growing system. More particularly, the present invention relates to a plant-growing system that may be mounted on a wall and that includes a decorative cover.

### BACKGROUND OF THE INVENTION

Plant-growing systems (e.g., hydroponic, aeroponic, and fogponic growing systems) are a convenient option for growing plants. For example, some plant-growing systems help to provide water, light, and fertilizer to plants.

However, existing plant-growing systems are not without deficiencies. For example, existing systems are designed based purely on utilitarian considerations and lack aesthetic or visual appeal. This results in structures that are visually unappealing and clash with typical home décor. Moreover, conventional plant—growing systems-even those designed for indoor use—are bulky and occupy considerable floor space. This presents a challenge for consumers who wish to integrate plant cultivation into their living spaces without sacrificing valuable floor space or compromising the aesthetics or visual harmony of the space. Thus, consumers seeking to incorporate greenery and plant-cultivation into their living space face a tradeoff between functionality, floor space, and visual appeal.

Additionally, some systems incorporate automation, sensors, and other electronic components, these “smart” systems often lack aesthetic appeal and seamless integration into a home environment. Further, these systems can be complex, expensive, and may not offer the modularity and user-friendly features necessary for convenient home use. Thus, a need exists for a space-efficient, aesthetically pleasing, and intelligent plant growth system that can provide automated environmental control and is tailored for indoor home environments.

### SUMMARY OF THE INVENTION

A plant growth system or wall hanging configured to grow one or more plants is provided. The wall hanging includes a cover that may have a cover or display such as a photograph, a painting, an electronic display (e.g., an LCD display), etc. positioned and located thereon. In addition, the cover may be coupled to an array system with one or more plant holders, which may include one or more cameras, sensors, or other electronic components in some cases. The plant holders are positioned and located adjacent to through-holes on the cover. As such, the plants in the plant holders may extend through the cover.

In addition, the wall hanging may include a grow light for providing light to the plants. In some embodiments, the grow light may be coupled to a mount. However, in other embodiments, the grow light may be moveable between a first position and a second position. When the grow light is in the first position, the grow light may be positioned and located adjacent to the cover. In contrast, when the grow light is in the second position, the grow light may be positioned and located outwardly from the cover. Thus, the grow light may direct light toward the plants when the grow light is in the second position.

In some embodiments, the plant growth system may include a sensor module configured to monitor and collect data regarding plant conditions, environmental conditions, etc., thereby providing comprehensive feedback on the growing environment. A processor may analyze the data from the sensor module and may facilitate automatic responses to changing plant needs and/or environmental conditions. An actuation module may be in communication with the processor and may be configured to perform adjustments of one or more parameters, and a user interface module may be provided to enable a user to interface with and/or control the system. The plant growth system may further include a hydroponic module configured to direct fluid to the plants, a nutrient management module configured to retain and dispense one or more nutrients or nutrient solutions, and a grow light module configured to emit light toward the plants.

The plant growth system may be modular in design. Key components such as the frame, cover, plant holders, sensor module, control module, actuation module, hydroponic module, and grow light module are interchangeable and customizable. This modularity may allow users to adapt the system aesthetically and functionally to accommodate different environments, plant types, etc. The body of the system may include an interchangeable frame, allowing for customization of aesthetics and materials. The cover is also interchangeable and can be configured to function as an in-situ germination chamber when in a closed position.

These aspects are merely illustrative of the innumerable aspects associated with the present invention and should not be deemed as limiting in any manner. These and other aspects, features, and advantages of the present invention will become apparent from the following detailed description when taken in conjunction with the referenced drawings.

### BRIEF DESCRIPTION OF THE DRAWINGS

For a better understanding of the present invention, reference may be made to the following accompanying drawings.

FIG. 1 is a perspective view of a wall hanging constructed according to the teachings hereof, the wall hanging in a first position.

FIG. 2 is a front elevation view of a cover of the wall hanging of FIG. 1.

FIG. 3 is a front elevation view of an array system of the wall hanging of FIG. 1.

FIG. 4 is a side elevation view of the cover and array system of FIGS. 2 and 3, respectively.

FIG. 5 is a perspective view of an array unit of the array system of FIG. 2.

FIG. 6 is a cross-section section view of the array unit of FIG. 5.

FIG. 7 is a perspective view of a plant holder of the array unit of FIGS. 5 and 6.

FIG. 8 is a perspective view of the wall hanging of FIG. 1 in a second position.

FIG. 9A is a perspective view of a second embodiment of a wall hanging constructed according to the teachings hereof, the wall hanging in a first position.

FIG. 9B is a perspective view of the wall hanging of FIG. 9A, the wall hanging in a second position.

FIG. 10A is a perspective view of a third embodiment of a wall hanging constructed according to the teachings hereof, the wall hanging in a first position.

FIG. 10B is a perspective view of the wall hanging of FIG. 10A, the wall hanging in a second position.

FIG. 11 is a perspective view of a fourth embodiment of a wall hanging constructed according to the teachings hereof.

FIG. 12 is a perspective view of a fifth embodiment of a wall hanging constructed according to the teachings hereof.

FIG. 13 is a schematic depiction of a plant growth system constructed according to the teachings hereof.

FIG. 14 is a schematic depiction of a first fluid delivery system of the plant growth system of FIG. 13.

FIG. 15 is a schematic depiction of a second fluid delivery system of the plant growth system of FIG. 14.

### DETAILED DESCRIPTION OF THE INVENTION

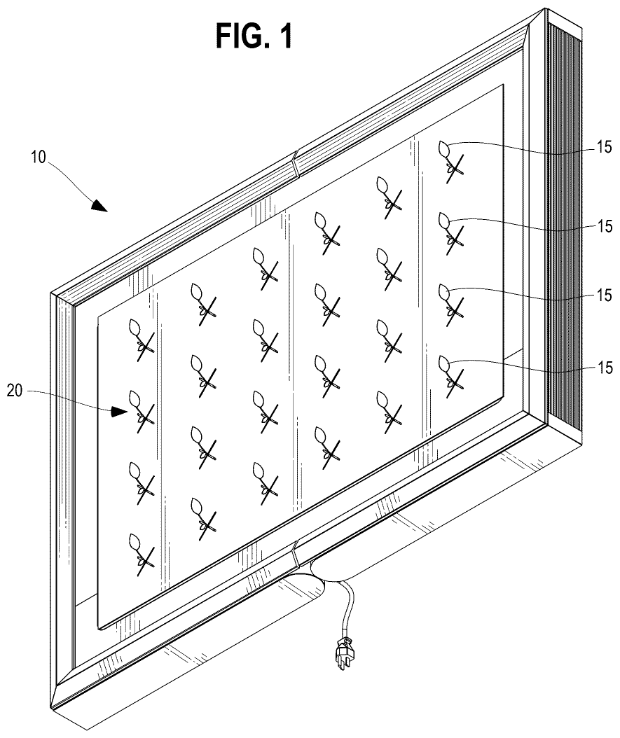

FIG. 1 illustrates a plant growth system including a body or wall hanging 10 configured for growing one or more plants 15. The wall hanging 10 may be mounted on a vertical surface such as a wall (not illustrated) similarly to a framed piece of art. For example, the wall hanging 10 may be configured for mounting on a variety of vertical surfaces such as walls, partitions, screens, furniture, and the like. The wall hanging 10 may be mounted via any suitable mechanism or technique including brackets (e.g., L-shaped, Z-shaped, etc.), adhesives, hooks, support legs, and/or other mounting mechanisms or components. In some embodiments, the wall hanging 10 may be freestanding. For example, the wall hanging 10 may lean against a vertical surface without being directly coupled to it. The modularity of the wall hanging 10 allows for interchangeable frames and mounting mechanisms to suit various aesthetic and installation preferences.

The wall hanging 10 may include a cover 20 that the plants 15 extend at least partially through. The cover 20 may be generally planar and sized to correspond to the dimensions of the body of the wall hanging 10. As described in further detail below, the cover 20 may be designed to provide an aesthetically pleasing visible surface for the wall hanging 10 (e.g., transforming the wall hanging 10 into a decorative element) and/or to act as a functional interface, potentially influencing the environment for the plants 15. The cover 20 may be modular and interchangeable, allowing users to customize the visual appearance and/or the functional properties of the wall hanging 10.

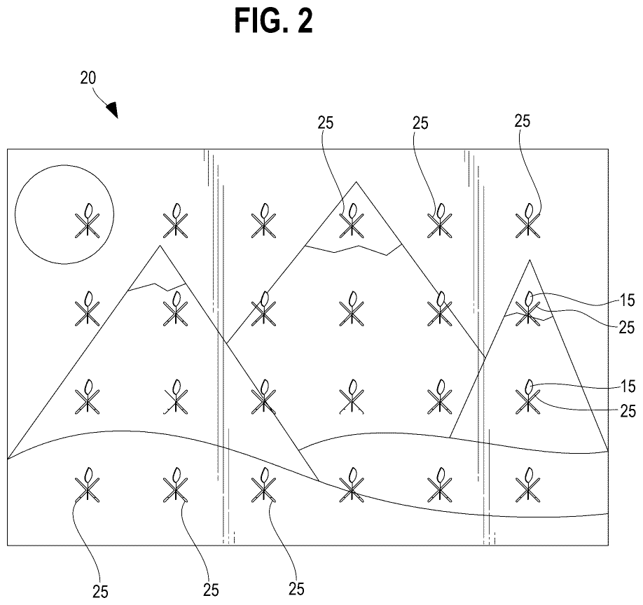

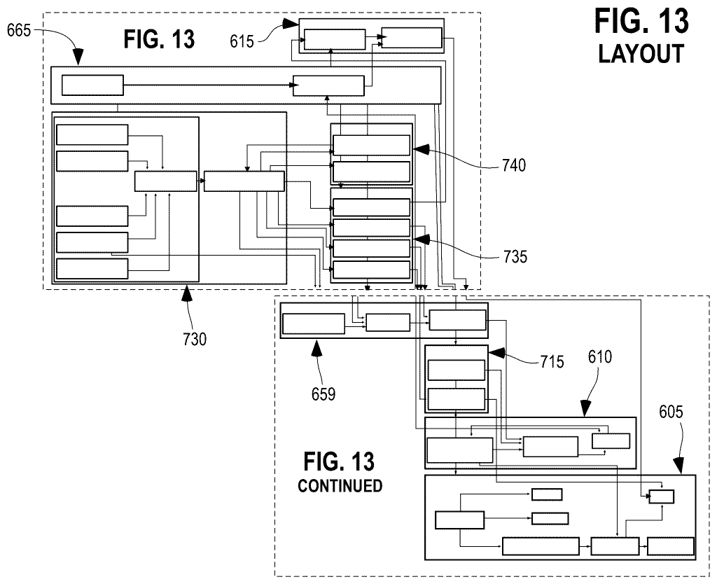

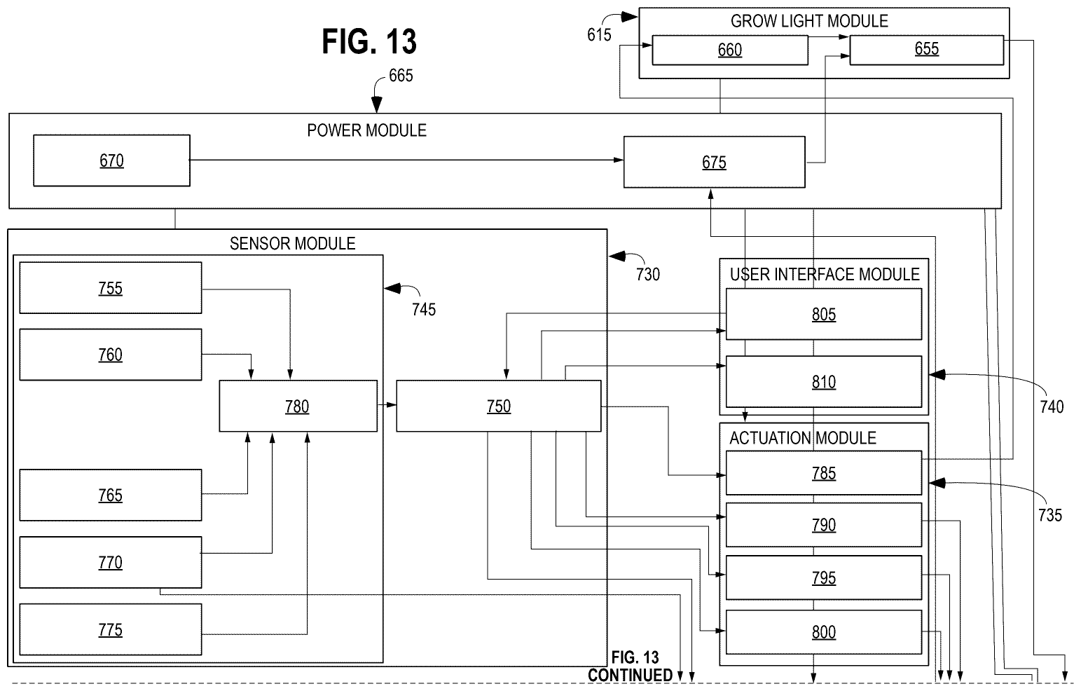

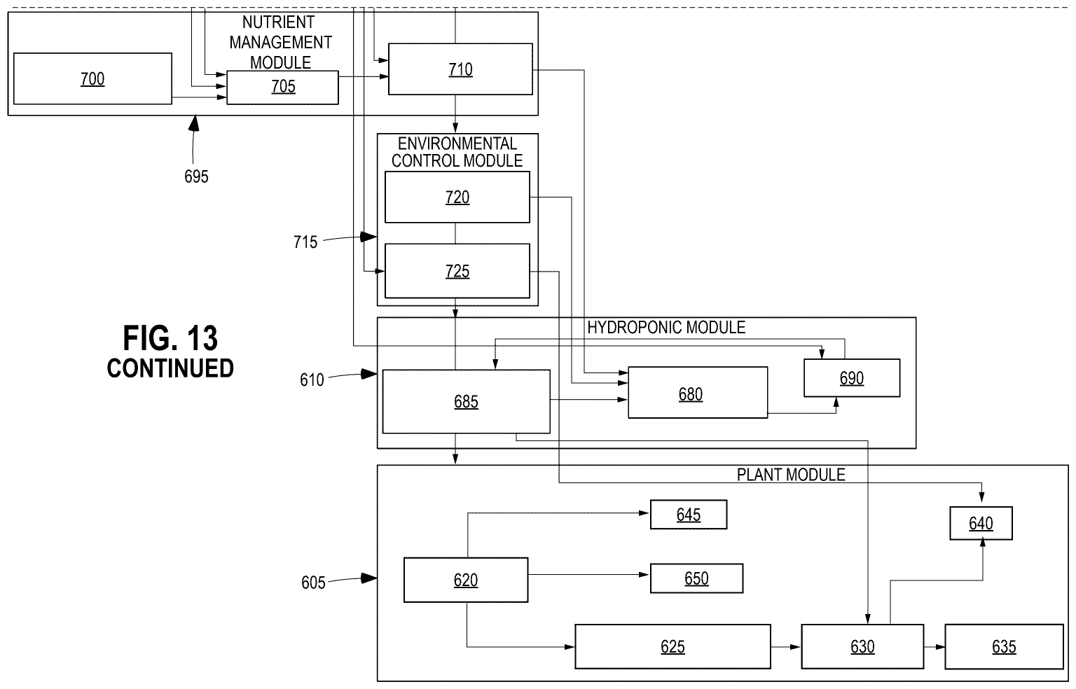

As illustrated in FIG. 2, in some embodiments, the cover 20 may include a painting or a photograph. However, in other embodiments, the cover 20 may be a material such as canvas, plastic, wood, metal, fabric, other materials, or combinations thereof, and the cover 20 may be imparted with a solid color, gradient, pattern, visual effect or texture, or other design. In some cases, the cover 20 may include or may be formed from “living materials” such as vine, moss, and the like. In further embodiments, the cover 20 may be provided in the form of an electronic display (e.g., an LCD screen, interactive touch screen, etc.) configured to display a desired graphic or series of graphics. For example, the cover 20 may be provided in the form of a user interface module (e.g., the user interface module 740 of FIG. 13) configured to receive user input or adjustments, display plant health data, environmental data, system settings, trend analysis, anomaly detection alerts, or perform other functions. In this way, the cover 20 may enhance the smart functionality of the system by facilitating real-time feedback and control. In other embodiments, the cover 20 may be provided in other forms.

In addition, the cover 20 may include through-holes 25 for the plants 15 to extend through. For example, the cover 20 may include a plurality of through-holes 25, and the through-holes 25 may be selectively positioned on the cover 20 such that the plants 15 may at least partially extend therethrough and may be visible from a front of the wall hanging 10. In some embodiments, the through-holes 25 may be formed by two intersecting slits (e.g., forming an X-shape), thereby enabling the through-hole 25 to accommodate plant stems of various diameters and enabling some flexibility in the position of the plant 15 within the through-hole 25. However, in other embodiments, the through-holes 25 may be provided in any suitable form (e.g., openings having a circular, ovoid, rectangular, irregular, or other shape).

In the example of FIG. 2, the cover 20 may include twenty-four through-holes 25 arranged in a grid-like pattern having four rows and six columns. However, in other embodiments, there may be more or fewer through-holes 25 arranged in any suitable configuration. For example, in some embodiments, the through-holes 25 may be arranged in a circular pattern or a spiral pattern. In some embodiments, the through-holes 25 may be substantially evenly distributed on the cover 20, whereas in other embodiments, the through-holes 25 may be concentrated in or limited to one or more finite regions of the cover 20. For example, the through-holes 25 may be grouped and positioned to coincide with a specific design element or image on the cover 20, such as a region of the cover 20 depicting a plant or flower.

Beyond its aesthetic function, the cover 20 may also serve as an environmental interface regulating one or more environmental conditions affecting the plants 15. In some embodiments, the cover 20 may be configured to provide an integrated or in-situ germination system within the wall hanging 10. For example, the cover 20 may be configured to be movable between a closed position and an open position. The cover 20, when in the closed position, may create a localized environment within the wall hanging 10 that is at least partially enclosed and is conducive to seed germination. For example, in the closed position, the cover 20 may act as a natural barrier to light and/or air, for example, in order to reduce light exposure and trap humidity within the wall hanging 10 to create a “plant growth area.” The function of the cover 20 as an in-situ germination chamber is enhanced by the interchangeable nature of the cover 20, which may enable users to select covers with specific light and/or air permeability characteristics optimized for germination.

In some embodiments, the cover 20 may be formed from a material (e.g., paper, mesh, other materials, combinations thereof, etc.) selected based on desired characteristics such as air permeability and light permeability. Further, the cover 20 may include materials and/or coatings configured to offer some degree of light diffusion or reflection. In other embodiments, the cover 20 may be provided in any suitable form and may be configured to regulate the temperature, humidity, and/or other conditions to which the plants 15 are exposed.

In some embodiments, the in-situ germination function of the wall hanging 10 may incorporate a gradual acclimation process. For example, after a pre-determined “germination period” (e.g., a pre-determined time interval), the cover 20 may be progressively opened. In other words, the cover 20 may move at least partially from the closed position to the open position when the germination period expires. The progressive opening of the cover 20 may take place over a period of time such that the plants 15 can gradually acclimate to ambient conditions (e.g., ambient air and light conditions). In this way, progressively opening the cover 20 may reduce or prevent any shock experienced by the nascent plants 15 and facilitate necessary developmental processes of the plants 15 such as phototropism and gravitropism.

As mentioned above, the cover 20 may be configured to be modular and/or interchangeable. For example, the cover 20 may be detachably coupled to the wall hanging 10 via various coupling mechanisms (e.g., clips, magnets, interlocking panels, sliding mechanisms, etc.) such that the cover 20 can be conveniently removed and replaced. This enables users to customize the visual appearance of the wall hanging 10 and to alter the functional properties of the wall hanging 10 by installing the desired cover 20.

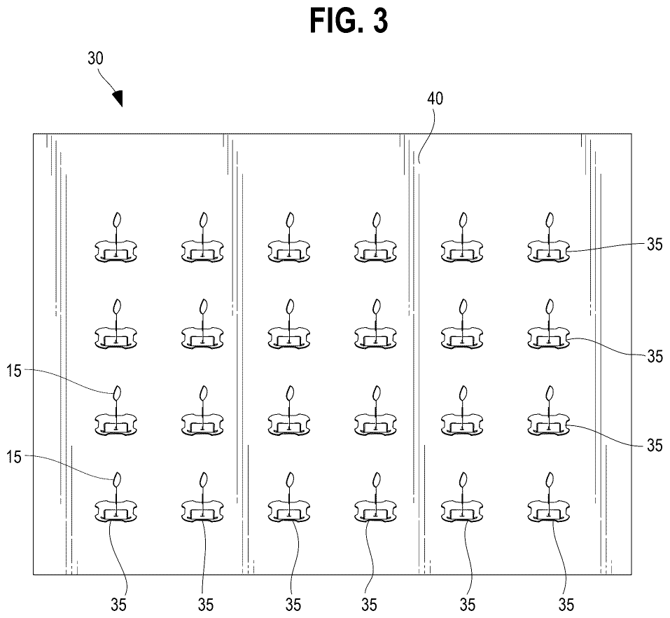

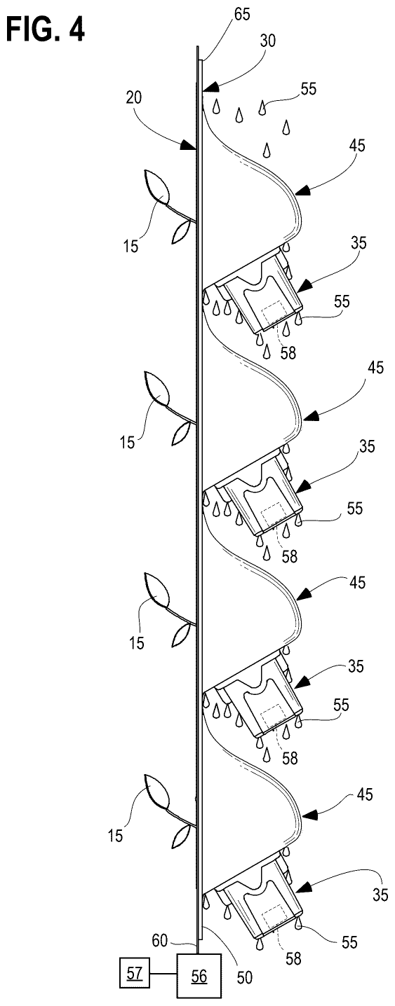

FIG. 3 illustrates an array system 30 configured for retaining one or more plant holders 35 on the wall hanging 10. The plant holders 35 may be modular and/or interchangeable such that a user can conveniently remove and/or replace the plant holders 35 as desired, allowing for customization based on plant size and type. The array system 30 may be positioned behind the cover 20, as can be seen in FIG. 4, and may be configured to support the plant holders 35 and/or to facilitate the flow of fluid toward the plant holders 35. The array system 30 includes a front surface 40 that is selectively couplable with the cover 20 (see, e.g., FIG. 2). For example, the front surface 40 may be configured to be detachably coupled to the cover 20 and/or other components of the wall hanging 10. However, in other embodiments, the array system 30 may be integrally formed with the cover 20.

As illustrated in FIG. 4, the array system 30 may include one or more array units 45 that are each configured to receive one of the plant holders 35. The array units 45 may protrude outwardly from a rear surface 50 of the array system 30, and the array units 45 may be integrally formed with the array system 30 or may be coupled thereto. Further, the array units 45 may be arranged on the array system 30 such that the plant holders 35 are positioned and located adjacent to the through-holes 25 of the cover 20 (see, e.g., FIG. 2). However, other configurations for the array units 45 are also foreseeable. In some embodiments, the array units 45 may be provided as modular units configured to be detachably coupled to the array system 30. For example, the array units 45 may be interchangeable and may be arranged in a variety of different configurations depending on the circumstances. However, in other embodiments, the array units 45 may be formed integrally with the array system 30.

The wall hanging 10 may be configured to provide fluid 55 (e.g., water, a nutrient solution, combinations thereof, etc.) to each of the plant holders 35, for example, via a hydroponic module as described below with reference to FIG. 13, to nourish the plants 15. For example, a reservoir 56 may be provided to retain a supply of the fluid 55. In some embodiments, the reservoir 56 may be positioned and located proximate to a lower region 60 of the wall hanging 10. In these instances, the reservoir 56 may be coupled to and/or in communication with a pump 57 configured to direct fluid from the lower region 60 to an upper region 65 of the wall hanging 10, for example, via one or more pipes or conduits (not illustrated). Once the fluid 55 has been transported from the reservoir 56 to the upper region 65 of the wall hanging 10 (e.g., by the pump 57), the fluid 55 may flow from the upper region 65 toward the lower region 60 via gravity (e.g., in a gravity-fed cascading system). In other instances, the reservoir 56 may be positioned and located proximate to the upper region 65, and the pump 57 may be omitted. As the fluid 55 flows downwardly, each of the array units 45 may receive the fluid 55 and guide the fluid 55 toward the various plant holders 35. Thus, the array units 45 preferably help with providing the fluid 55 to the plants 15. However, in further embodiments, the fluid 55 may be sprayed upwardly onto the plants 15 (e.g., as a mist provided by a misting system), may be provided by a drip irrigation system or a hydroponic circulation system, or may be provided via any other suitable fluid delivery system. The fluid delivery system may be part of a hydroponic module (e.g., the hydroponic module 610 of FIG. 13), which may be modular such that the reservoir 56 and/or other components of the fluid delivery system are interchangeable.

In some embodiments, the wall hanging 10 may further include one or more sensors 58 configured to monitor and facilitate operation of the wall hanging 10 to maintain suitable conditions for the plants 15. The sensors 58 may be incorporated into a sensor module (e.g., the sensor module 730 of FIG. 13), which may be a modular and/or interchangeable component configured to generate plant condition data, environmental data, and/or other data affecting the growing environment of the plants 15. For example, the sensors 58 may include soil moisture sensors, water level sensors, temperature sensors, humidity sensors, pressure sensors, nutrient sensors (e.g., pH sensors, EC sensors, ISE sensors), and the like. Additionally, in some instances, one or more sensors 58 may be provided in the form of visual sensors such as cameras, depth sensors, and the like. The sensors 58 may be selectively positioned throughout the system (e.g., positioned on or coupled to the wall hanging 10), including being positioned on or within the plant holders 35, on or within the reservoir 56, on or within other components of the system, and/or in the ambient environment surrounding the wall hanging 10. The sensors 58 may be in communication with a controller or processor (e.g., the processor 750 of FIG. 13) via any suitable wired or wireless communication protocol.

In some embodiments, one or more of the plant holders 35 may include a soil moisture sensor for detecting the level of moisture in the plant holder 35. When one of the soil moisture sensors detects that the level of moisture is below a threshold value, the pump may be powered on such that the fluid 55 is provided to the plants 15. However, when one of the soil moisture sensors detects that the level of moisture is above a threshold value, the pump may be powered off to prevent overwatering the plants. In addition, the wall hanging 10 may include a water level sensor positioned and located in the reservoir 56. If the water level sensor detects that the volume of fluid 55 in the reservoir 56 is below a threshold value, the wall hanging 10 may send a notification to the user (e.g., via a mobile device). Further, the wall hanging 10 may include temperature sensors, humidity sensors, and/or pressure sensors, cameras, depth sensors, and/or other sensors configured to collect data regarding the wall hanging 10, the plants 15, the reservoir 56, the plant holders 35, and/or other components. In other words, the sensors 58 may be provided in any suitable form. In some embodiments, multiple sensors 58 may be provided with one or more of the plant holders 35, the plant holders 35 may each include multiple sensors 58, and additional sensors 58 may be positioned elsewhere on the wall hanging 10. The data from any of the one or more sensors 58 may be used (e.g., by the processor 750 or other processor or controller) to analyze, monitor, regulate, and/or adjust the growing conditions of the plants 15.

Turning to FIG. 5, the array units 45 may include features configured to facilitate the delivery of fluid to the associated plant holder 35 and/or plant 15. For example, each of the array units 45 may include a channel 70 for guiding the fluid 55 to the plant holders 35. The channels 70 may be provided in the form of grooves, depressions, conduits, and the like, and may be formed on an upper side 75 of each array unit 45. Thus, the channels 70 may receive the fluid 55 as the fluid 55 flows downwardly through the wall hanging 10. Then, once the fluid 55 is received by one of the channels 70, the channel 70 may convey the fluid 55 to a spout 80, and the spout 80 may discharge the fluid 55 toward the plant holder 35. Thus, the array units 45 may be configured to guide the fluid 55 to the plant holders 35.

FIG. 5 illustrates a lateral side 82 and a rear side 83 of one of the plant holders 35. The lateral side 82 and the rear side 83 may each include a permeable portion 85 and a drip feature 90. However, it is to be understood that the other sides of the plant holder 35, which are not illustrated, may also include a permeable portion 85 and a drip feature 90.

The permeable portion 85 may be configured to allow fluid 55 to pass into and out of the plant holder 35, thereby facilitating hydration of the plant 15 and drainage of excess fluid. For example, the permeable portion 85 may be formed by perforations, mesh, porous material, and/or other suitable materials or structures that allow fluid passage while retaining the contents of the plant holder 35. The plant holder 35 may include permeable portions 85 positioned on multiple (e.g., all) sides of the body 120, and in some instances, the permeable portion 85 may extend across substantially all of the exterior surface of the body 120.

The drip feature 90 may be configured to manage excess fluid 55 that may adhere to an exterior of the plant holder 35 or the array unit 45. For example, when the plant holder 35 is received by the array unit 45, the permeable portion 85 on the rear side 83 may be positioned and located to receive the fluid 55 from the spout 80. However, as fluid 55 exits the spout 80, some of the fluid 55 may adhere to plant holder 35 and/or the lower side 95 of the array unit 45. The adhered fluid 55 can then flow around the plant holder 35. The drip feature 90 is positioned to intercept this adhered fluid 55 as it flows around the plant holder 35. For example, the drip feature 90 may intercept the adhered fluid 55 and may direct the fluid 55 downwardly to prevent fluid 55 from flowing toward the cover 20 (see, e.g., FIG. 4).

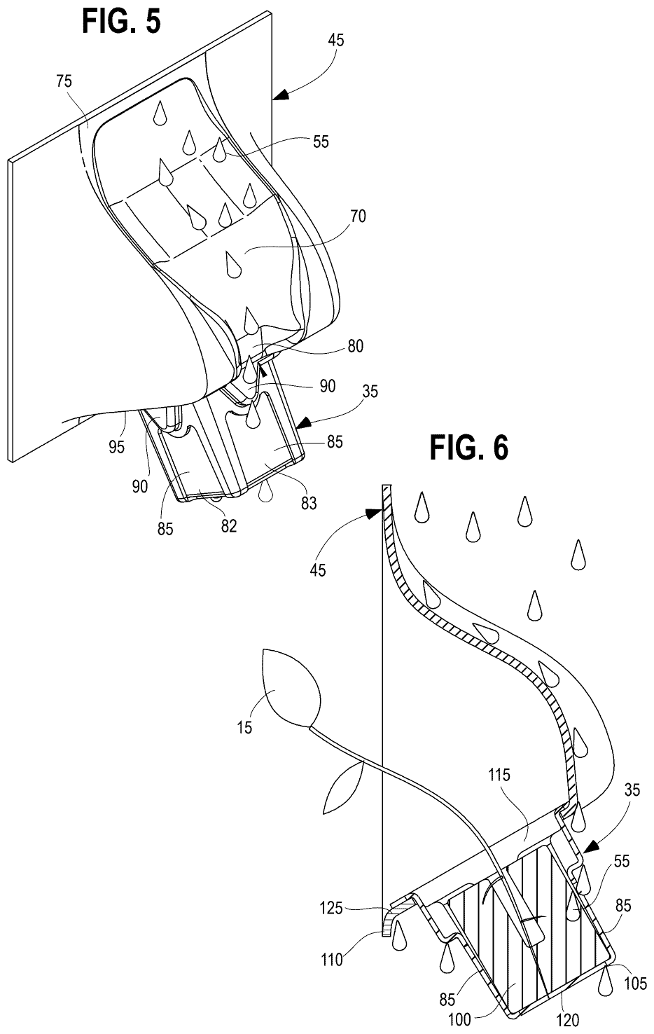

Referring to FIG. 6, a hydroponic grow media 100 may be positioned within the plant holder 35 and configured to support the roots of the plant 15 and retain moisture and/or nutrients. For example, the hydroponic grow media 100 may be provided in the form of a variety of material such as a sponge, peat pellets, mineral wool, gravel, soil, and the like. The fluid 55 may be received by a hydroponic grow media 100 after the fluid 55 passes through one of the permeable portions 85. The hydroponic grow media 100 may retain the fluid 55 so that the plant 15 can absorb the fluid 55 therefrom. However, if the hydroponic grow media 100 is saturated, the excess fluid 55 may exit the plant holder 35 proximate to a lower end 105 (e.g., through one of the permeable portions 85). After exiting the plant holder 35, the excess fluid 55 may continue to flow downwardly to another array unit 45.

As the fluid 55 exits the plant holder 35, some of the fluid 55 may flow toward the cover 20 (see, e.g., FIG. 4). However, each of the array units 45 may include a lip 110 that curves downwardly. As such, the lip 110 may receive the fluid 55 flowing toward the cover 20, and the lip 110 may direct the fluid 55 downwardly to another array unit 45. Thus, the lip 110 may also help to prevent fluid 55 from reaching the cover 20.

In some embodiments, the wall hanging 10 may a gravity-driven cascading fluid delivery system. As mentioned above, a reservoir 56 proximate to the lower region 60 may act as a source of fluid 55 (e.g., water, nutrient solutions, combinations thereof, etc.). The fluid 55 may be moved from the reservoir to the upper region 65 via a pump or other mechanism. Once the fluid 55 is elevated to the upper region 65, the wall hanging 10 may leverage gravity for downward distribution of the fluid 55 to the plants 15. As the fluid 55 flows from the upper region 65 to the lower region 60, the fluid 55 interacts with (e.g., encounters, flows around) the array units 45. As described above, the array units 45 may guide the fluid 55 toward the various plant holders 35 via the channels 70, spouts 80, permeable portions 85, and/or other parts. In this way, the wall hanging 10 may provide simple, energy-efficient delivery of fluid 55 to the plants 15.

In other embodiments, other fluid delivery methods such as drip irrigation, misting systems, timed-release systems, hydroponic circulation systems, and/or suitable methods or mechanisms may be employed to deliver the fluid 55 to the plants 15. For example, the fluid 55 may be sprayed upwardly onto the plants 15 in the form of a mist. In some embodiments, the delivery of fluid 55 to the plants 15 may be automated to some degree—for example, the sensors 58 may monitor internal and/or external environmental conditions (e.g., moisture, temperature, light levels, nutrient levels, etc.) and regulate the delivery of fluid 55 as needed. As one non-limiting example, a control module 735 and an actuation module 740 may utilize data received from a sensor module 730 to monitor plant conditions and/or environmental conditions, as depicted in FIG. 13 and described in further detail below. In such cases, the sensors 58 may be in communication with an external device or application (e.g., a mobile application interface) that enables a user to remotely monitor and control the growth of the plants 15.

In some embodiments, the delivery system may be configured to provide more comprehensive environmental control. For example, the wall hanging 10 may be configured to provide the plants 15 with nutrients, fertilizers, pesticides, and/or other substances in addition to the fluid 55. A filtration mechanism (not illustrated) may also be provided to create a closed-loop system that recirculates and filters fluids to conserve resources and reduce waste. For example, the filtration mechanism may be configured to maintain water quality and prevent the buildup of harmful substances in the fluid 55 by removing debris, pathogens, mineral precipitates, and/or other substances from the circulating fluid 55.

FIG. 6 further illustrates the manner in which the plant holders 35 are received by the array units 45. In particular, each of the array units 45 may include an aperture 115 that is sized and shaped to receive a body 120 of the plant holders 35. For example, the aperture 115 may be shaped and sized to complement the body 120 to provide a snug and stable fit. In addition, in some instances, each of the plant holders 35 may include a flange 125 that is configured to engage with the lip 110. Thus, the flanges 125 may help to retain the plant holders 35 in the apertures 115.

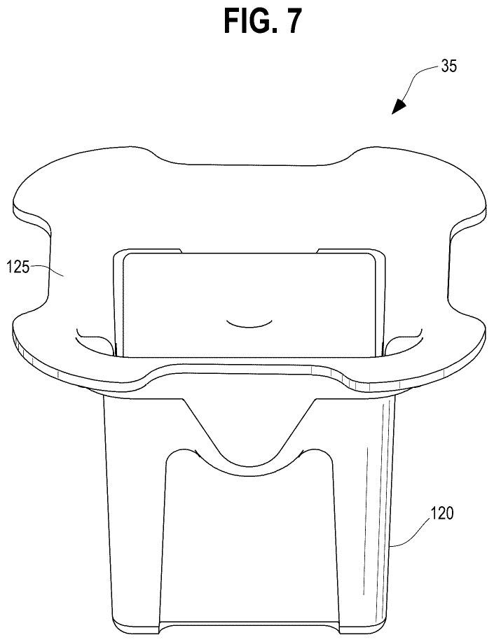

FIG. 7 illustrates the plant holder 35 in greater detail. As a non-limiting example, in some embodiments, the body 120 of the plant holder 35 may be shaped as a rectangular prism that is substantially symmetrical. Thus, the plant holder 35 may be placed in one of the array units 45 of the array system 30 (see, e.g., FIG. 3) in at least four different configurations. However, in other embodiments, the plant holder 35 may be provided with any desirable shape and/or size. Moreover, in some embodiments, the plant holders 35 are each provided in substantially the same form; however, one or more of the plant holders 35 may differ structurally from one or more other plant holders 35. The plant holders 35 may be modular and/or interchangeable such that a user may select from a variety of plant holders 35 optimized for different plant sizes, root systems, and/or other parameters.

The flange 125 may wrap around or circumscribe an upper portion of the body 120 and extend outwardly therefrom. The flange 125 may be configured to engage or interact with the lip 110 of the associated array unit 45 (see, e.g., FIG. 6). For example, the flange 125 and the lip 110 may be configured to engage each other in a snap fit, friction fit, or via any other suitable mechanism such that the plant holder 35 is retained within the aperture 115 of the array unit 45.

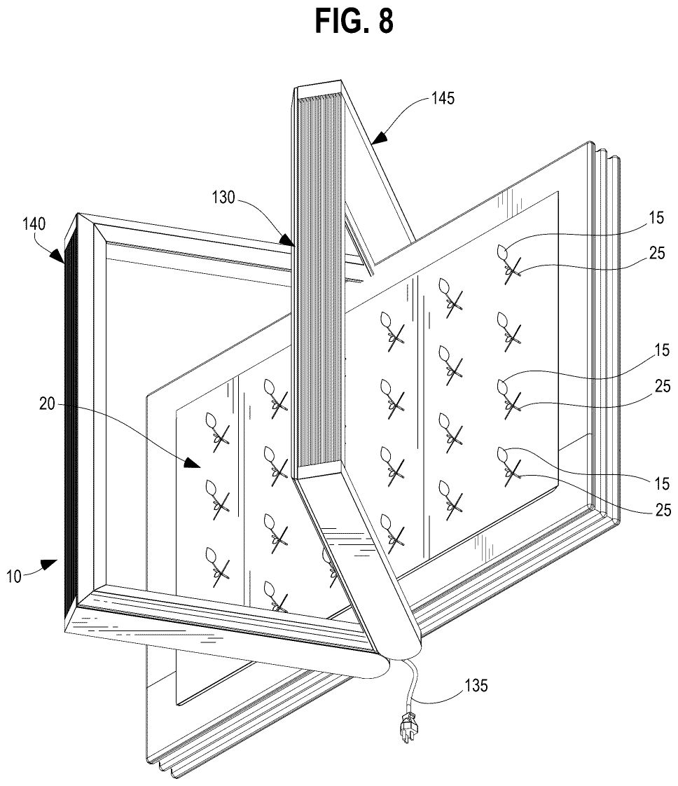

Turning to FIG. 8, the wall hanging 10 may include a grow light 130 for providing light to the plants 15. The grow light 130 may be provided as a modular and/or interchangeable part. In some embodiments, the grow light 130 may be incorporated into a grow light module (e.g., the grow light module 615 of FIG. 13). For example, the grow light 130 may be designed to provide supplemental artificial light to the plants 15, particularly in indoor environments where natural light may be insufficient. The grow light 130 may include one or more LEDs (not illustrated) that receive power from a power cable 135. The grow light 130 may be selectively moveable between a first position (see, e.g., FIG. 1) and a second position (see, e.g., FIG. 8). In some embodiments, an actuator (e.g., part of the actuator module 735 of FIG. 13) may be configured to control movement of the grow light 130 between the first position and the second position.

When the grow light 130 is in the first position, a first arm 140 and a second arm 145 may be positioned and located adjacent to the cover 20. As such, the arms 140, 145 may be oriented substantially parallel to the cover 20 when the grow light 130 is in the first position. In other words, the arms 140, 145 may be substantially coplanar with the cover 20 when the grow light 130 is in the first position. In contrast, when the grow light 130 is in the second position, the first arm 140 and the second arm 145 may be rotated outwardly from the cover 20 such that the LEDs are directed at the cover 20. To transition the grow light 130 from the first position to the second position, a user may manually move the grow light 130.

However, in other embodiments, movement of the grow light 130 may be controlled by an actuator (e.g., the actuation module 735 of FIG. 13) such as a motor (not illustrated) or a hydraulic cylinder (not illustrated). The actuator may be configured to move the grow light 130 in response to control signals (e.g., signals received from the control module 730 of FIG. 13). These control signals may be generated based on a schedule, user input via a switch, a web application, and/or a mobile application, or the control signals may be generated automatically in response to sensor data. The grow light 130 may be positioned adjacent to the cover 20 when the grow light 130 is in the first position, and the grow light 130 may be positioned at a distance of at least about 15 centimeters from the cover 20 when the grow light 130 is in the second position. Furthermore, the LEDs may automatically emit light when the grow light 130 is placed in the second position. However, in other embodiments, the LEDs may be powered on and off in response to a schedule, a switch, a web application, and/or a mobile application.

The wall hanging 10 may be provided in the form of a modular system. For example, the cover 20, array system 30, plant holders 35, grow light 130, and/or other components of the wall hanging 10 (including the plant module 605, hydroponic module 610, grow light module 615, sensor module 730, control module 735, actuation module 740, and/or other components of the plant growth system 600 depicted in FIG. 13) may be designed to be coupled together or assembled such that one or more of the components of the wall hanging 10 are interchangeable and customizable. In this way, the wall hanging 10 may enable a user to customize the system's appearance and/or functionality. The modularity of the wall hanging 10 may extend to additional components of the system not specifically described herein as well as further embodiments of the present invention, as discussed in further detail below.

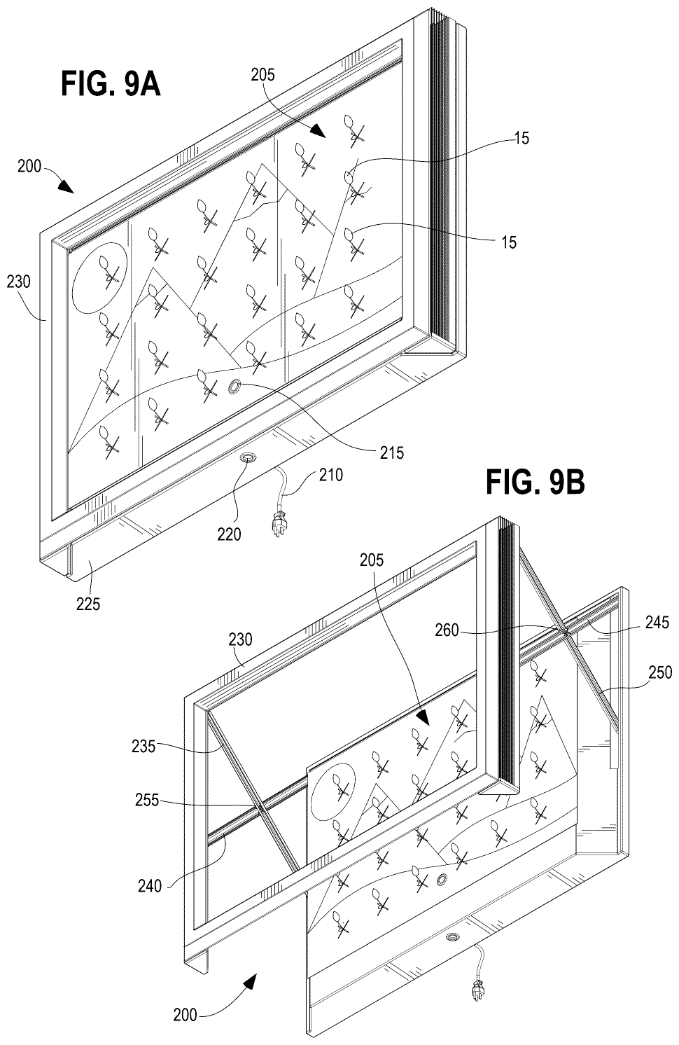

FIG. 9A illustrates an alternative embodiment of a wall hanging 200. Similar to the wall hanging 10, the wall hanging 200 includes a cover 205 that one or more plants 15 extend through. Further, the wall hanging 200 includes a power cable 210 for providing power to the wall hanging 200. However, in contrast to the wall hanging 10, the wall hanging 200 includes a fill port 215 and a drain port 220. The fill port 215 is configured for selectively adding the fluid 55 (see, e.g., FIG. 4) to the wall hanging 200, and the drain port 220 is configured for selectively removing the fluid 55 from the wall hanging 200. The fill port 215 may be positioned and located on the cover 205, and the drain port 220 may be positioned and located proximate to a lower region 225 of the wall hanging 200. However, in other embodiments, the fill port 215 and the drain port 220 may be positioned and located elsewhere on the wall hanging 200 (e.g., on a rear surface or a side surface).

Referring to FIGS. 9A and 9B, the wall hanging 200 may include a grow light 230 that is moveable between a first position (as illustrated in FIG. 9A) and a second position (as illustrated in FIG. 9B). When the grow light 230 is in the first position, the grow light 230 may be positioned and located adjacent to the cover 205. In contrast, when the grow light 230 is in the second position, the grow light 230 may be positioned and located at a distance from the cover 205 such that one or more LEDs (not illustrated) are directed toward the cover 205. To transition the grow light 230 from the first position to the second position, the grow light 230 may be moved outwardly from the wall hanging 200 (e.g., manually or via an actuator). As the grow light 230 moves outwardly, a first linkage arm 235, a second linkage arm 240, a third linkage arm 245, and a fourth linkage arm 250 (illustrated in FIG. 9B) may rotate outwardly to guide the grow light 230. In particular, the first linkage arm 235 and the second linkage arm 240 may be rotatably coupled together at a first joint 255, and the third linkage arm 245 and the fourth linkage arm 250 may be rotatably coupled together at a second joint 260. Thus, the linkage arms 235, 240, 245, 250 may move similar to a scissor mechanism that extends outwardly as the grow light 230 transitions from the first position to the second position.

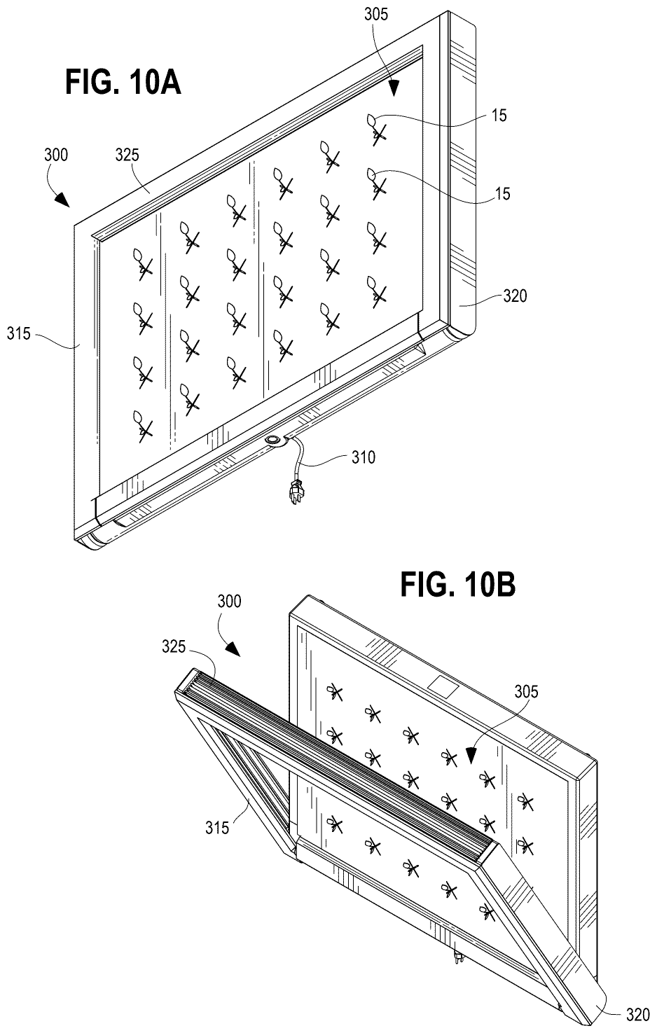

FIG. 10A illustrates another alternative embodiment of a wall hanging 300. Similar to the wall hangings 10, 200, the wall hanging 300 includes a cover 305 that one or more plants 15 extend through. Further, the wall hanging 300 includes a power cable 310 configured for providing power to the wall hanging 300.

Referring to FIGS. 10A and 10B, the wall hanging 300 may include a grow light 315 that is rotatably coupled to the wall hanging 300 proximate to a lower region 320. When the grow light 315 is in a first position (as illustrated in FIG. 10A), the grow light 315 may be positioned and located adjacent to the cover 305. As such, the grow light 315 may be oriented substantially parallel to the cover 305 when the grow light 315 is in the first position. In contrast, when the grow light 315 is in the second position (as illustrated in FIG. 10B), an upper region 325 of the grow light 315 may be rotated outwardly from the cover 305. As a result, one or more LEDs (not illustrated) may be directed toward the cover 305 when the grow light 315 is in the second position.

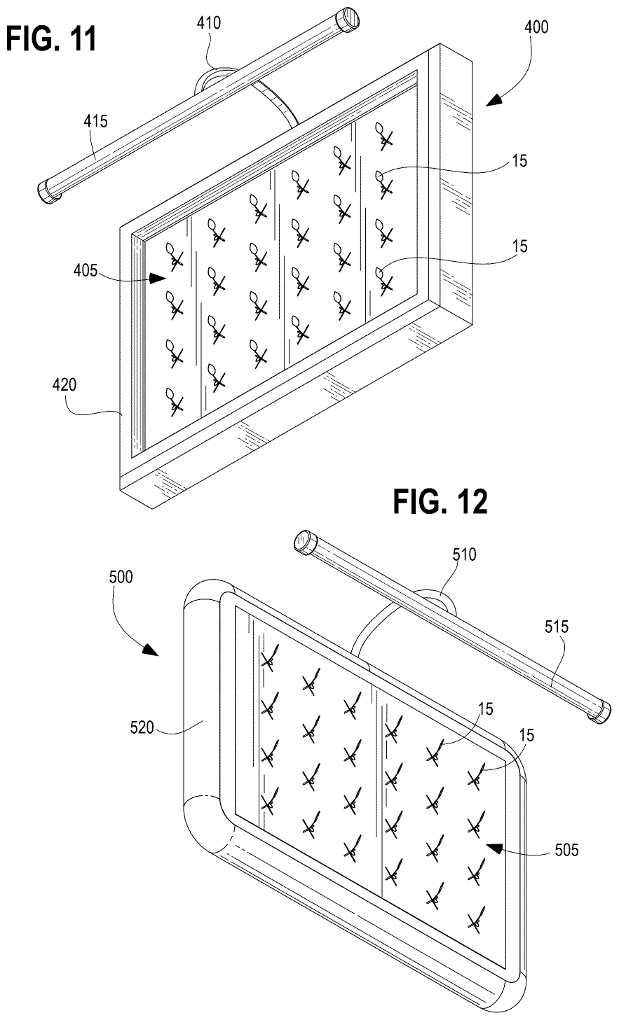

FIG. 11 illustrates another alternative embodiment of a wall hanging 400. Like the wall hangings 10, 200, 300, the wall hanging 400 includes a cover 405 that one or more plants 15 extend through. However, in contrast to the wall hangings 10, 200, 300, the wall hanging 400 includes a mount 410 coupled to a grow light 415. The mount 410 may protrude outwardly from a frame 420 of the wall hanging 400, and the mount 410 may be curved so that grow light 415 is directed toward the cover 405. Further, the mount 410 may have a hollow interior for wires and cables to extend through. Thus, the mount 410 may help to conceal the cables and wires for the grow light 415.

FIG. 12 illustrates another alternative embodiment of a wall hanging 500. Like the wall hanging 400, the wall hanging 500 includes a cover 505, a mount 510, and a grow light 515. However, in contrast to the wall hanging 400, the wall hanging 500 includes a frame 520 that has rounded edges. As such, the wall hanging 500 has a different visual appearance than the wall hanging 400, and a consumer may select the wall hanging 10, 200, 300, 400, 500 that suits their preferences.

In some embodiments, the frame (e.g., frame 420, 520) of the wall hanging (e.g., wall hanging 10, 200, 300, 400, 500) may be modular and/or interchangeable such that a user can conveniently detach and/or replace the frame as desired. In this way, the wall hanging 10, 200, 300, 400, 500 may enable a user to select from a range of frame styles, materials, finishes, etc., depending on a desired aesthetic.

Turning to FIG. 13, an exemplary configuration for a plant growth system 600 is depicted schematically and represented as several interconnected modules, with each module including one or more distinct components. The plant growth system 600 may include a plant module 605 including a physical apparatus supporting one or more plants 15, a hydroponic module 610 configured to direct fluid 55 to the plant module 605 to nourish and/or hydrate the plants 15, and a grow light module 615 configured to emit light toward the plants 15. Additionally, the plant growth system 600 may include (among other components) a sensor module 730, an actuation module 735, and a user interface module 740, all of which may be modular and/or interchangeable components.

The plant module 605 may be substantially similar, for example, to the wall hanging 10 and may include a frame, mounting mechanism, and/or other parts. The plant module 605 may include one or more components and/or may be configured to perform one or more functions as described above with reference to the wall hanging 10, 200, 300, 400, 500.

As shown in FIG. 13, in some embodiments, the plant module 605 may include a body 620, for example, provided in the form of a frame or a wall mounting device. The body 620 may support or be coupled to a decorative and/or functional cover 625 and one or more plant holders 630. The cover 625 may be substantially similar to the cover 20 described above. The plant holders 630 may be substantially similar to the plant holders 35 described above and may be configured to receive a grow media 635 and one or more plants 640 (e.g., the plants 640 may be substantially similar to the plants 15). Additionally, in some embodiments, the plant module 605 may include a fill port 645 and/or a drain port 650. For example, the fill port 645 may enable a user to add fluid (e.g., the fluid 55) to the plant module 605, and the drain port 650 may enable a user to remove fluid from the plant module 605, as needed.

The grow light module 615 may include a grow light unit 655 and a grow light controller 660 configured to control the operation of the grow light unit 655. The grow light unit 655 may be substantially similar to the grow light 130, 230, 315, 415, 515 discussed above, or the grow light unit 655 may be provided in the form of any other suitable light source. In some embodiments, the grow light unit 655 and/or the grow light module 615 may be physically coupled to or formed integrally with the plant module 605. In other embodiments, the grow light module 615 may be provided separately from the plant module 605.

The plant growth system 600 may further include a power module 665 configured to provide power from an external power source 670 to the grow light module 615. The power module 665 may include a governor 675 configured to regulate the power supplied to the grow light module 615. For example, the governor 675 may employ various mechanisms or techniques (e.g., LED drivers, pulse width modulation or PWM, zoning, etc.) to regulate or manipulate the power supplied to the grow light module 615 such that the light provided by the grow light unit 655 may be customizable. Thus, the power module 665 may be in communication with and may supply power to the grow light module 615 and/or other components of the plant growth system 600. The grow light unit 655 may be arranged to direct light toward the plants 640.

The hydroponic module 610 may be configured to supply one or more fluids (e.g., fluid 55) such as water, a nutrient solution, other substances, and combinations thereof to the plant module 605, thereby supplying the plants 640 with hydration and/or nutrients. The hydroponic module 610 may include a reservoir 680 (e.g., substantially similar to the reservoir 56 described above) configured to retain a supply of fluid. A fluid delivery system 685 of the hydroponic module 610 may include a means for directing fluid from the reservoir 680 to the plants 640. For example, the fluid delivery system 685 may employ gravity, drip irrigation, misting, timed-release, hydroponic circulation, and/or other methods or mechanisms to direct fluid from the reservoir 680 to the plants 640. In some embodiments, a pump 690 in communication with the reservoir 680 may be provided to facilitate movement of fluid from the reservoir 680 (e.g., to counteract the force of gravity).

In some embodiments, a nutrient management module 695 may be in communication with the hydroponic module 610 (e.g., with the reservoir 680) and may be configured to supply the reservoir 680 with a desired mixture of fluids. For example, the nutrient management module 695 may include one or more containers 700 retaining one or more substances (e.g., nutrients known to facilitate plant growth), a mixing system 705, and one or more mixing valves 710. The mixing system 705 may be configured to produce a mixture comprising one or more of the substances contained in the containers 700 and, in some instances, water. The mixing valves 710 may be configured to enable precise control of the composition of the mixture and/or to enable precise control of the amount of the mixture that is directed to the reservoir 680. In some embodiments, the mixing system 705 and/or mixing valves 710 may be provided in the form of electronic components capable of being controlled or operated via manual controls (e.g., buttons, switches, etc.) and/or via a remote device (e.g., tablet, smartphone, etc.). In other embodiments, the nutrient management module 695 may be omitted.

In some embodiments, fluid may move directly from the nutrient management module 695 to the hydroponic module 610, where the fluid may be received within the reservoir 680. However, in other embodiments, an environmental control module 715 may be positioned to intercept and/or treat the fluid on its way to the hydroponic module 610. For example, the environmental control module 715 may include an aerator 720 configured to oxygenate the fluid passing through the environmental control module 715 and/or one or more fan units 725 configured to facilitate cooling, transpiration, and/or other desired processes or effects.

In some embodiments, the plant growth system 600 may incorporate one or more computerized or electronic components configured to gather and/or analyze data, automate or partially automate one or more functions of the plant growth system 600, enable a user to interface with and control the plant growth system 600 (or one or more components thereof), or perform other functions. For example, the user interface module 740 may be provided as a modular component of the plant growth system 600. The user interface module 740 may include an electronic display provided on the cover 20 (see FIG. 1). The electronic display may be configured to display plant health data, environmental data, trend analysis of plant growth data, and anomaly detection alerts for plant health issues. The user interface module 740 may be configured to receive user input for system adjustments via a touch screen interface on the electronic display, buttons, dials, voice commands, and/or via a mobile application interface for remote monitoring and control. The mobile application interface may enable remote monitoring and adjustment of system parameters, viewing of sensor data, and receiving alerts.

The sensor module 730 may include the sensors 58 discussed above, as well as additional and/or alternative components. An exemplary configuration of the sensor module 730 is depicted in FIG. 13, but it should be understood that the sensor module 730 may be provided in a variety of forms and may be configured to perform a variety of functions. In some embodiments, the sensor module 730 may include a sensor array 745 and a processor 750 in communication with the sensor array 745. The sensor array 745 may include one or more of each of the following: plant sensors 755, nutrient sensors 760, environmental sensors 765, system sensors 770, and/or specialized sensors 775. The sensor array 745 may further include a data acquisition node 780 in communication with the aforementioned sensors and configured to receive, record, transmit, and/or analyze data collected therefrom.

The plant sensors 755 may be configured to monitor the status, health, growth, etc. of the plants 640 and/or other components of the plant module 605. The plant sensors 755 maybe positioned on the plant module 605 or other components of the plant growth system 600, as desired. For example, the plant sensors 755 may be provided in the form of a camera, vision system, and/or other optical sensor configured to detect anomalies or visually apparent diseases and/or to monitor plant height, leaf area, stem diameter, overall biomass, growth rate over time, flower count, flower growth rate, and/or other characteristics. For example, the plant sensors 755 can include spectrometers, hyperspectral imaging sensors, and the like. In some embodiments, the processor 750 (or other component of the sensor module 730) may be provided with image processing software configured to receive and interpret data from the plant sensors 755. The plant sensors 755 may also be provided in the form of a depth sensor (e.g., time of flight sensors, structured light sensors, and the like) configured to perform three-dimensional mapping of the plants 640. Additionally, in some embodiments, the plant sensors 755 may be provided in the form of a weight sensor or load cell configured to measure changes in plant weight, a strain gauge configured to measure stem elongation and/or leaf expansion, a proximity sensor (e.g., infrared, ultrasonic, etc.) configured to detect plant presence or proximity to a light source, and/or other suitable sensors or data collection devices.

In some instances, the plant sensors 755 may further include sensors configured to observe or monitor the physiology or biological state of the plants 640. For example, the plant sensors 755 can include leaf temperature sensors (e.g. infrared thermometers, contact thermocouples, etc.) configured to monitor plant stress and transpiration rates, chlorophyll fluorescence sensors configured to assess photosynthetic efficiency and overall health, sap flow sensors configured to measure the rate of water and nutrient uptake by a given plant 640, stem diameter variation sensors (e.g., dendrometers) configured to monitor plant water status and real-time growth, leaf wetness sensors configured to detect condensation or excess moisture, and the like.

The plant sensors 755 may be positioned proximate to the plants 640. For example, the plant sensors 755 may be positioned within the plant holders 630 (e.g., similar to the position of the sensors 58 with respect to the plant holders 35, as shown in FIG. 4). Alternatively, the plant sensors 755 may be positioned in any suitable location and may be positioned on or coupled to any suitable component of the plant module 605. For example, plant sensors 755 provided in the form of an optical sensor such as a camera may be retained at a distance from the plants 640.

The nutrient sensors 760 may be configured to monitor the status, physical characteristics, chemical attributes, etc. of the hydroponic module 610, the nutrient management module 695, and/or components thereof (e.g., a supply of fluid or other substance retained within the reservoir 680, the containers 700, and/or other components of the plant growth system 600). The nutrient sensors 760 may be positioned on the hydroponic module 610, the nutrient management module 695, and/or other components of the plant growth system 600, as desired. In some embodiments, the nutrient sensors 760 may include nutrient

concentration sensors and/or electrical conductivity (EC) sensors configured to measure an amount of dissolved salts within a nutrient solution and provide an indication regarding the nutrient solution's overall strength. The nutrient sensors 760 may also include pH sensors, dissolved oxygen (DO) sensors, turbidity sensors, suspended solids sensors, oxidation-reduction potential (ORP/Redox) sensors, specific ion sensors (ISEs), water hardness sensors, calorimetric sensors, reagent-based sensors, microbial sensors, pathogen sensors, and/or other sensors configured to measure or detect various characteristics of a fluid or a solution. Additionally, the nutrient sensors 760 may include temperature sensors, liquid level sensors, liquid flow sensors, pressure sensors, and/or other sensors configured to measure or detect physical attributes of a fluid or a solution.

The environmental sensors 765 may be configured to measure or detect one or more environmental characteristics or attributes affecting the plant growth system 600. The environmental sensors 765 may, in some embodiments, be positioned on the plant module 605 (e.g., on the body 620). However, in other embodiments, the environmental sensors 765 may be positioned in any suitable location on the plant growth system 600. The environmental sensors 765 may include air temperature sensors, humidity sensors (e.g., hygrometers), air flow sensors (e.g., anemometers), carbon dioxide (CO2) sensors, volatile organic compound (VOC) sensors, air quality sensors (e.g., particulate matter sensors such as PM2.5, PM10, etc.), ambient light sensors (e.g., lux meters, PAR sensors, etc.), optical spectrometers, UV radiation sensors, and the like.

The system sensors 770 may be configured to monitor the performance of the plant growth system 600, for example, by detecting errors, leaks, deteriorating performance, etc. In some embodiments, the system sensors 770 may be configured to initiate indicators or alerts that may be provided to a user to inform the user regarding certain aspects of the performance of the plant growth system 600. The system sensors 770 may be positioned in any suitable location on the plant growth system 600.

In some embodiments, the system sensors 770 may include one or more pump performance sensors configured to monitor the performance of the hydroponic module 610 and, in particular, the pump 690. For example, the system sensors 770 may include current sensors configured to monitor the electrical current draw of the pump 690, vibration sensors configured to detect abnormalities in the vibrations emanating from the pump 690, and/or other sensors configured to monitor the pump 690. In this way, the system sensors 770 may be configured to detect failures, blockages, wear, and/or other phenomena impacting the operation of the hydroponic module 610.

The system sensors 770 may also include leak detection sensors (e.g., configured to detect leaks from the reservoir 680, containers 700, and/or other components), power consumption sensors, energy meters, system uptime/downtime monitoring sensors, and the like. Additionally, the system sensors 770 may include safety sensors such as overheat sensors, water level overflow sensors, electrical fault sensors, ground fault circuit interrupters (GFCIs), and the like.

In some embodiments, the plant growth system 600 may include one or more specialized sensors 775 configured to monitor other aspects of the plant growth system 600. For example, the specialized sensors 775 may include acoustic sensors configured to monitor sounds produced by plant processes (e.g., cavitation, transpiration, etc.), bioimpedance sensors configured to measure the electrical impedance of plant tissues, electrochemical sensors configured to perform advanced nutrient monitoring for real-time complex nutrient analysis, quantum dot sensors configured to perform multi-analyte detection in nutrient solutions and/or plant tissues, and/or other sensors. In other instances, the specialized sensors 775 may be omitted. Additionally, any of the aforementioned sensors (i.e., sensors 58, 755, 760, 765, 770, 775) may be provided in the form of individual sensors or wireless sensor networks (WSNs).

The data acquisition node 780 may be in communication with some or all of the aforementioned sensors (i.e., sensors 58, 755, 760, 765, 770, 775) and may be configured to receive information therefrom via wired and/or wireless electronic communication. Thus, the data acquisition node 780 may be configured to store and/or relay the information it receives from the sensor array 745. For example, the data acquisition node 780 may be in communication with the processor 750, which may in turn be in communication with one or more other components of the plant growth system 600.

The processor 750 may be configured to read, store, process, and/or analyze the information received from the data acquisition node 780 and produce outputs (e.g., information readable by a user) or take action based on that information. As one non-limiting example, the processor 750 may be in communication with the nutrient management module 695 (e.g., with the mixing system 705), and may be configured to adjust the mixture of nutrients provided by the nutrient management module 695 based on data received from the nutrient sensors 760. The processor 750 may be in communication with other modules or individual components of the plant growth system 600 and may be configured to adjust their operation based on real-time data in a similar manner.

Additionally, the processor 750 may be in communication with the actuation module 735 and/or the user interface module 740. The actuation module 735 may serve as an intermediary between the processor 750 and various operative components of the plant growth system 600. For example, the actuation module 735 may include a light actuator 785 operatively coupled to the grow light module 615, a nutrient actuator 790 operatively coupled to the nutrient management module 695, a fan actuator 795 operatively coupled to the environmental control module 715, a pump actuator 800 operatively connected to the hydroponic module 610, and/or other actuators operatively coupled to other components of the plant growth system 600. In this way, the actuation module 735 may enable the processor 750 to control or adjust the operation of the grow light controller 660, the mixing valves 710, the fan unit 725, the pump 690, and/or other components of the plant growth system 600 to automatically adjust environmental parameters and system settings to optimize plant growth.

The user interface module 740 may serve as an intermediary between the processor 750 and a user, thereby enabling a user to interface with the plant growth system 600 (e.g., monitor performance, adjust various metrics or parameters, alter settings, etc.). For example, the user interface module 740 may include an interface component 805, a visualization component 810, and/or additional or alternative parts. The interface component 805 may be configured to enable a user to operate and/or interface with the plant growth system 600. For example, the user may engage the interface component 805 via dictation, a touch screen, buttons, dials, and/or other suitable mechanisms. In some instances, the interface component 805 may be multi-modal in that it may enable a user to engage the plant growth system 600 via two or more different mechanisms.

The visualization component 810 may be configured to enable a user to read or collect data from the plant growth system 600 (e.g., data collected by the sensor array 745). For example, the visualization component 810 may be provided in the form of an electronic screen or display configured to depict numerical data, graphs, charts, and/or other visuals or graphics. Both the interface component 805 and the visualization component 810 may be provided in any suitable form. In some embodiments, the interface component 805 and/or the visualization component 810 may be integrally formed with the plant growth system 600. In other embodiments, the interface component 805 and/or the visualization component 810 may be provided in the form of an external device such as a smartphone or laptop configured for wired or wireless communication with components of the plant growth system 600 such as the sensor module 730.

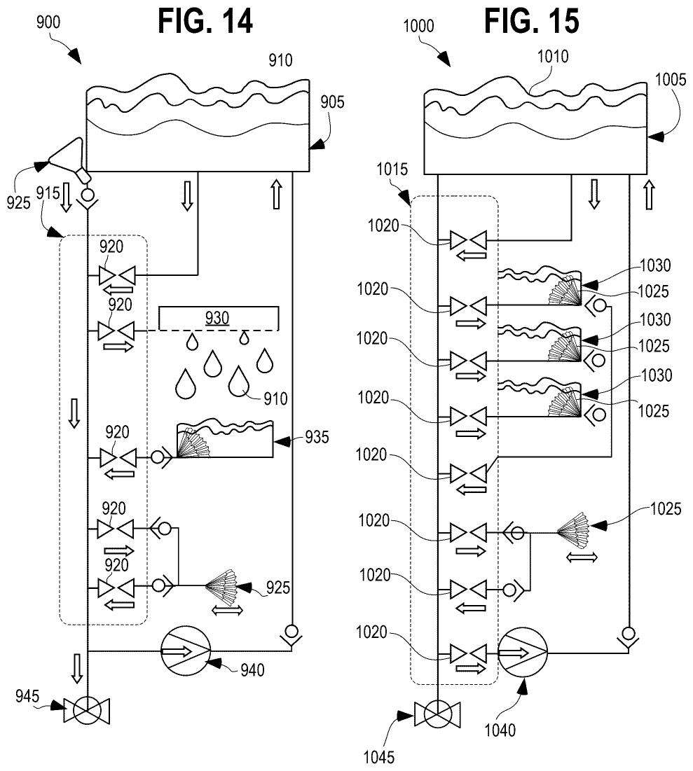

In some embodiments, the hydroponic module 610, or one or more components thereof (e.g., the fluid delivery system 685), may be provided in the form of a fluid delivery system 900 as depicted schematically in FIG. 14, a fluid delivery system 1000 as depicted schematically in FIG. 15, and/or other forms not specifically described herein.

As shown in FIG. 14, the fluid delivery system 900 may include a tank 905 positioned proximate to an upper portion of the plant growth system 600 (e.g., the tank 905 may be positioned proximate to the upper region 65, as shown in FIG. 4). However, in other embodiments, the tank may be positioned proximate to a lower portion of the plant growth system 600, or may be positioned in any suitable location. The tank 905 may be configured to retain a supply of fluid 910 (e.g., water, nutrient solution, other substances, and/or combinations thereof).

The tank 905 may be in communication with a valve assembly 915 configured to control the distribution of fluid 910. For example, in some embodiments, the valve assembly 915 may be provided in the form of a solenoid valve manifold including one or more two way valves 920. In other embodiments, the valve assembly 915 may be provided in any other suitable form. In some embodiments, an inlet 925 may be positioned between the tank 905 and the valve assembly 915, and the fluid 910 may flow to the valve assembly 915 via the inlet 925. In some embodiments, the inlet 925 may be a semi-automatic inlet (e.g., operation of the inlet 925 may be at least partially automated) and may include a filtering component.

The valve assembly 915 may be configured to direct fluid 910 to a drip system 930 of the fluid delivery system 900. For example, the drip system 930 may be configured to distribute the fluid 910 to the plants (e.g., plants 640) via gravity. However, in other embodiments, the drip system 930 may be omitted and other fluid delivery mechanisms may be provided, as discussed above. In the example of FIG. 14, the fluid delivery system 900 may include a settling tank 935 positioned proximate to a lower portion of the plant growth system 600 and configured to collect run-off or fluid 910 distributed by the drip system 930 but not received or collected by the plants 640.

In some instances, the fluid delivery system 900 may include a pump 940 (e.g., the pump 940 may be the pump 690 of FIG. 13) configured to direct the fluid 910 back to the tank 905. Additionally, the fluid delivery system 900 may include an empty port 945 (e.g., configured to enable the removal of fluid 910 from the fluid delivery system 900).

Turning to FIG. 15, the fluid delivery system 1000 may be substantially similar to the fluid delivery system 900. For example, the fluid delivery system 1000 may also include a tank 1005 positioned proximate to an upper portion of the plant growth system 600 and configured to retain a supply of fluid 1010. In other embodiments, the tank 1005 may be positioned proximate to a lower portion of the plant growth system 600.

The tank 1005 may be in communication with a valve assembly 1015 configured to control the distribution of the fluid 1010. The valve assembly 1015 may be substantially similar to the valve assembly 915 and may include one or more two way valves 1020. The fluid delivery system 1000 may include an inlet 1025 provided in substantially the same form as the inlet 925. Additionally, the fluid delivery system 1000 may include a pump 1040 (e.g., the pump 1040 may be the pump 690 of FIG. 13) configured to direct the fluid 1010 back to the tank 1005. Additionally, the fluid delivery system 1000 may include an empty port 1045 (e.g., configured to enable the removal of fluid 1010 from the fluid delivery system 1000).

The fluid delivery system 1000 may include one or more gutters 1030 configured to direct the fluid 1010 to the plants 640. For example, the gutters 1030 may be positioned at various heights with respect to the body 620 (e.g., the gutters 1030 may be arranged to align with the plant holders 630). In some embodiments, each gutter 1030 may include a filter or inlet 1025. The two way valves 1020 of the valve assembly 1015 may be configured to open and close independently from one another such that fluid 1010 may be directed to one or more gutters 1030 but not others. In the example of FIG. 15, the fluid delivery system 1000 may include eight two way valves 1020. However, in other embodiments, the fluid delivery system 1000 may include any suitable number of two way valves 1020.

While the fluid delivery systems 900, 1000 represent exemplary fluid delivery systems that can be provided with the hydroponic module 610 to distribute fluid to the plants 640, other fluid delivery systems are envisioned and may include additional and/or alternative components as compared to the fluid delivery systems 900, 1000.

In some further embodiments, a wall hanging (not illustrated) may be provided with additional features to help facilitate growing the plants 15. For example, alternative embodiments of a wall hanging may include a bubbler (not illustrated) and/or an aerator (not illustrated). The bubbler and/or the aerator may draw air from the ambient environment, and the bubbler and/or the aerator may pump the air into the fluid 55 (e.g., via tubing and/or an air stone). Thus, the bubbler and/or the aerator may help to keep the fluid 55 fresh. In addition, alternative embodiments of a wall hanging may include one or more fans (not illustrated) to help facilitate growing the plants 15. The one or more fans may be positioned and located on or adjacent to a grow light assembly (e.g., the grow light assemblies 130, 230, 315, 415, 515 illustrated FIGS. 8-12). Further, the one or more fans may be oriented such that an axis of rotation is directed toward or away from the one or more plants 15. Thus, the one or more fans may push or pull air past the foliage of the plants 15 to increase transpiration rates and to facilitate growing the plants 15.

From the foregoing, it will be seen that the various embodiments of the present invention are well adapted to attain all the objectives and advantages hereinabove set forth together with still other advantages which are obvious, and which are inherent to the present structures. It will be understood that certain features and sub-combinations of the present embodiments are of utility and may be employed without reference to other features and sub-combinations. Since many possible embodiments of the present invention may be made without departing from the spirit and scope of the present invention, it is also to be understood that all disclosures herein set forth or illustrated in the accompanying drawings are to be interpreted as illustrative only and not limiting. The various constructions described above and illustrated in the drawings are presented by way of example only and are not intended to limit the concepts, principles, and scope of the present invention.

Many changes, modifications, variations, and other uses and applications of the present invention will, however, become apparent to those skilled in the art after considering the specification and the accompanying drawings. All such changes, modifications, variations, and other uses and applications which do not depart from the spirit and scope of the invention are deemed to be covered by the invention, which is limited only by the claims which follow.

What is claimed is:

1. A plant growth system comprising:
a body for supporting one or more plants;
a cover including one or more through-holes, each plant configured to extend at least partially through one of the through-holes; and
a grow light coupled to the body, the grow light movable between a first position and a second position.

2. The plant growth system of claim 1, further comprising a sensor module, an actuation module in communication with the sensor module, and a user interface module in communication with the sensor module.

3. The plant growth system of claim 2, further comprising an array system positioned proximate to the cover, the array system including one or more interchangeable plant holders configured to receive the one or more plants.

4. The plant growth system of claim 3, wherein each of the one or more plant holders includes a channel and a spout configured to direct fluid toward one of the one or more plants.

5. The plant growth system of claim 3, wherein each of the one or more plant holders includes at least one permeable portion configured to allow fluid to flow into and out of the plant holder and at least one drip feature.

6. The plant growth system of claim 1, wherein the cover is interchangeable.

7. The plant growth system of claim 1, wherein the grow light includes a first arm and a second arm, wherein the first arm and the second arm are positioned adjacent to the cover when the grow light is in the first position, and wherein the first arm and the second arm each extend outwardly away from the cover such that the grow light is configured to emit light toward the cover when the grow light is in the second position.

8. A plant growth system comprising:
an interchangeable frame;
a plurality of plant holders coupled to the frame, the plurality of plant holders retaining a plurality of plants;
a cover including a plurality of through-holes, the plurality of plants each extending at least partially through one of the through-holes; and
a grow light configured to emit light toward the cover.

9. The plant growth system of claim 8, wherein the grow light is coupled to the frame via a mount, the mount configured to retain the grow light at a distance from the frame.

10. The plant growth system of claim 8, further comprising an array system including a plurality of array units, each array unit receiving one of the plant holders.

11. The plant growth system of claim 10, wherein each of the plurality of plant holders includes a flange and each of the plurality of array units includes a lip, and wherein the flange of the plant holder is configured to engage the lip of the associated array unit when the plant holder is received by the array unit.

12. The plant growth system of claim 8 further comprising a reservoir positioned proximate to a lower portion of the frame and retaining a supply of fluid and a pump in communication with the reservoir and configured to direct the fluid from the reservoir to the plurality of plants.

13. The plant growth system of claim 8, wherein the grow light is movable between a first position in which the grow light is positioned adjacent to the frame and a second position in which the grow light is retained at a distance from the frame and configured to emit light toward the cover.

14. The plant growth system of claim 13, wherein the grow light includes a linkage arm mechanism configured to facilitate movement of the grow light between the first position and the second position.

15. A plant growth system comprising:
a body supporting one or more plants, the one or more plants being received by one or more plant holders coupled to the body;
a grow light movable between a first position and a second position and configured to emit light toward the one or more plants; and
a fluid delivery system configured to direct fluid toward the one or more plant holders.

16. The plant growth system of claim 15, wherein the fluid delivery system comprises a tank retaining the fluid, a valve assembly in communication with the tank, and at least one gutter in communication with the valve assembly and configured to direct the fluid to the one or more plants.

17. The plant growth system of claim 15, wherein each of the one or more plant holders includes a channel, a spout, and at least one permeable portion positioned proximate to the spout, the permeable portion configured to allow fluid to enter and exit the plant holder.

18. The plant growth system of claim 15, wherein the fluid delivery system comprises a reservoir positioned below the array system and configured to retain the fluid and a pump in communication with the reservoir and configured to move the fluid from the reservoir to an upper portion of the array system.

19. The plant growth system of claim 15, further comprising an interchangeable cover configured to be detachably coupled to the body, wherein the cover includes one or more through holes, and wherein the one or more plants are arranged to extend at least partially through the through-holes of the cover.

20. The plant growth system of claim 19, wherein the cover is configured to reduce light exposure and/or retain humidity such that the plant growth system provides an in-situ germination system.
